(19) United States
(12) Patent Application Publication
(10) Pub. No.: US 2004/0212370 A1
(43) Pub. Date: Oct. 28, 2004

(54) Electrochemical impedance spectroscopy apparatus and method of use thereof

(76) Inventors: Robert F. Cunningham, Harrisville, PA (US); Charles R. Coleman, Pittsburgh, PA (US)

Correspondence Address: Linda Pingitore, PPG Industries, Inc., One PPG Place, Pittsburgh, PA, 15272, US

(21) Appl. No.: 10/421,243

(22) Filed: Apr. 23, 2003

(51) Int. Cl. G01N 27/02

(52) U.S. Cl. 324/446; 324/693

(57) ABSTRACT

An electrochemical impedance spectroscopy apparatus includes a conduit having a first conductive probe positioned therein. One end of the conduit is coupled in a fluid tight manner to a surface of an electrically conductive object or a coating thereon whereupon an electrolyte solution disposed in the conduit is in fluid communication with the first conductive probe and the surface or the coating. A second conductive probe outside the conduit is moved into electrical contact with the object, either directly or via the coating. An AC signal applied between the first and second conductive probes is swept between a first frequency and a second frequency. A characteristic or property of the surface and/or the coating is determined from the response thereof to the swept AC signal.

### BACKGROUND OF THE INVENTION

1. Field of the Invention

The present invention relates to electrochemical impedance spectroscopy testing of a surface of an object or of a coating deposited to the surface.

2. Description of Related Art

Electrochemical impedance spectroscopy (EIS) is a technique well known in the art for measuring the quality of a surface of an objector of a coating deposited on the surface. To this end, various apparatus and methods have been devised for testing coating quality in situ.

One problem with in situ EIS testing of coating quality is the inability to define the area where EIS data is to be collected. Another problem is the inability to use a conventional EIS probe arrangement for testing a curved or arcuate surface of an object, for testing a surface of an object that is positioned other than horizontally, e.g., vertically or some angle between horizontally and vertically, or for testing the quality of a coating applied on such surface.

It is, therefore, desirable to provide an EIS apparatus and method of use thereof that can be used for testing a curved surface of an object or a surface of an object oriented other than horizontal. It is also desirable to provide an EIS apparatus and method of use thereof wherein contact with the object is made through a coating adjacent the area where the EIS testing actually occurs.

### SUMMARY OF THE INVENTION

The present invention is an electrochemical impedance spectroscopy apparatus that includes a conduit and a gasket coupled in a fluid tight manner to the conduit adjacent one end thereof. The gasket has an opening therethrough in fluid communication with an interior of the conduit. A side of the gasket opposite the conduit is coupleable in a fluid tight manner with coating applied over a surface of an object. The conduit, the gasket and the coating define a fluid tight vessel when the gasket is coupled in a fluid tight manner to the coating. A first electrode is positioned inside the vessel and a second electrode is positioned outside the vessel. The second electrode is responsive to the application of a suitable force thereto for piercing the coating to electrically contact the object.

The second electrode is operatively coupled to the conduit via a support bracket or the gasket. The second electrode can have an externally threaded body that is configured to threadedly mate with an internally threaded opening through the one of the support bracket and the gasket.

The gasket is configured to create with the coating a vacuum therebetween when the gasket is moved into contact with the coating. This vacuum couples the gasket and the coating together in a fluid tight manner. The gasket can include a vacuum channel operative in the manner of a suction cup for coupling the gasket and the coating together in the fluid tight manner.

Means can be provided for fluidly connecting a vacuum source in fluid communication between the gasket and the coating when the gasket is in contact with the coating. The vacuum source is operative on the means for fluidly connecting for coupling the gasket and the coating together in the fluid tight manner. The fluid connecting means can include a channel formed in the side of a gasket opposite the conduit.

Opposite ends of the conduit can be positioned parallel or transverse to each other. In one embodiment the conduit can have an L-shape.

An electrically conductive cover can be positioned over the end of the conduit opposite the gasket. The conduit can be formed from an electrically insulative material having a coating of electrically conductive material on an exterior surface thereof.

The invention is also an electrochemical impedance spectroscopy method. The method includes providing a conduit having a first conductive probe positioned therein. One end of the conduit is coupled in a fluid tight manner to a coating on a surface of an electrically conductive object whereupon an electrolyte solution disposed in the conduit is in fluid communication with the coating and the first conductive probe. The coating outside the conduit is perforated with a second conductive probe whereupon the second conductive probe is in electrical contact with the object. An AC signal is coupled between the first and second conductive probes. The AC signal is swept between a first frequency and a second frequency. The response of the coating and the object to the swept AC signal is determined and a characteristic or property of the coating is determined from this response.

If the exterior surface of the conduit has an electrically conductive film thereon the electrically conductive film can be connected to a reference potential. Similarly, if an electrically conductive cover is provided over the other end of the conduit, the electrically conductive cover can be connected to the reference potential.

The invention is also an electrochemical impedance spectroscopy apparatus that includes a conduit having a first electrically conductive probe positioned therein and a seal for coupling one end of the conduit in a fluid tight manner to a coating on a surface of an electrically conductive object whereupon an electrolyte solution disposed in the conduit is in fluid communication with the coating and the first conductive probe. A second electrically conductive probe is provided that is configured to penetrate the coating outside the conduit and electrically contact the object. Lastly, a means is provided for applying a sweep frequency AC signal to the first and second conductive probes, for determining a response of the coating and the object to the sweep frequency AC signal and for determining from this response a characteristic or property of the coating.

The body of the conduit can be formed whereupon when one end of the conduit is coupled to the coating when the surface is positioned at an angle relative to horizontal, the electrolyte solution does not exit the other end of the conduit.

The invention is also an electrochemical impedance spectroscopy apparatus that includes a conduit having ends that are positioned transverse with respect to each other and a gasket coupled in a fluid tight manner to the conduit adjacent one end thereof. The gasket has an opening therethrough in fluid communication with an interior of the conduit and a side of the gasket opposite the conduit coupleable in a fluid tight manner with a surface of an object or a coating applied over the surface of the object. The conduit, the gasket and the surface or the coating define a fluid tight vessel when the gasket is coupled in a fluid tight manner thereto. A first electrode is positioned inside the vessel and a second electrode is positioned outside the vessel and moveable into electrical contact with the object.

The second electrode can be responsive to the application of a suitable force thereto for piercing the coating to electrically contact the object. The second electrode can be operatively coupled to the conduit via one of a support bracket and the gasket. The second electrode can have an externally threaded body that is configured to threadedly mate with an internally threaded opening through the one of the support bracket and the gasket.

The gasket can be configured to create with the surface or the coating a vacuum therebetween when the gasket is moved into contact therewith. The vacuum can couple the gasket and the surface or the coating together in the fluid tight manner. The gasket can include a vacuum channel operative in the manner of a suction cup for coupling the gasket and the one of the surface and the coating together in the fluid tight manner.

Means can be provided for fluidly connecting a vacuum source in fluid communication between the gasket and the surface or the coating when the gasket is in contact therewith. The vacuum source can be operative on the means for fluidly connecting for coupling the gasket and the surface or the coating together in the fluid tight manner. The fluid connecting means can include a channel formed in the side of the gasket opposite the conduit.

The apparatus can also include an electrically conductive cover positionable over the end of the conduit opposite the gasket. The conduit can be formed from an electrically nonconductive material having a coating of electrically conductive material on an exterior surface thereof.

The invention is also an electrochemical impedance spectroscopy method that includes providing a first conductive probe positioned in a conduit having ends that are positioned transverse with respect to each other and coupling one end of the conduit in a fluid tight manner to a surface of an electrically conductive object or a coating deposited on the surface of the object whereupon an electrolyte solution disposed in the conduit is in fluid communication with the first conductive probe and the one of the surface and the coating. The surface of the object can be electrically contacted with a second conductive probe either directly or via the coating. An AC signal can be applied between the first and second conductive probes. The AC signal can be swept between a first frequency and a second frequency. From a response of the coating or the object to the swept AC signal a characteristic or property thereof can be determined.

Electrically contacting the surface of the object via the coating can include perforating the coating outside the conduit with the second conductive probe. The conduit can be electrically nonconductive. An electrically conductive film can be provided on the exterior surface of the conduit and the electrically conductive film can be connected to a reference potential. An electrically conductive cover can be provided over the other end of the conduit. The electrically conductive cover can be connected to the reference potential.

Lastly, the invention is an electrochemical impedance spectroscopy apparatus that includes a conduit having a first electrically conductive probe positioned therein and a seal for coupling one end of the conduit in a fluid tight manner to a surface of an electrically conductive object or a coating deposited on the surface whereupon an electrolyte solution disposed in the conduit is in fluid communication with the first conductive probe and the surface or the coating. A second electrically conductive probe can be configured to electrically contact the object one of directly or via the coating.

Means can be provided for applying a sweep frequency AC signal to the first and second conductive probes, for determining a response of the object and/or the coating to the sweep frequency AC signal and for determining from the response a characteristic or property thereof. A body of the conduit can be configured so that when the one end of the conduit is coupled to the coating when the surface is positioned at an angle relative to horizontal, the electrolyte solution does not exit the other end of the conduit.

The conduit can be electrically nonconductive. An electrically conductive film can be disposed on an exterior surface of the conduit. An electrically conductive cover can be positioned over the other end of the conduit. The second electrically conductive probe can be configured to penetrate the coating outside the conduit whereupon the second electrically conductive probe contacts the object.

### BRIEF DESCRIPTION OF THE DRAWINGS

FIG. 1 is a plan view of a first embodiment electrochemical impedance spectroscopy (EIS) apparatus positioned on a coating deposited on a surface of an object;

FIG. 2 is a section taken along lines 2-2 in FIG. 1;

FIG. 3 is a cross-sectional side view of an alternate first embodiment EIS apparatus positioned on a coating deposited on a surface of an object;

FIG. 4 is a side view of a second embodiment EIS apparatus positioned on a cross-section of a coating deposited on a surface of an object than horizontally;

FIG. 5 is a section taken along lines 5-5 in FIG. 4; and

FIG. 6 is a side view of an alternate second embodiment EIS apparatus positioned on a coating deposited on a surface of an object that is curved and oriented other than horizontally.

### DETAILED DESCRIPTION OF THE INVENTION

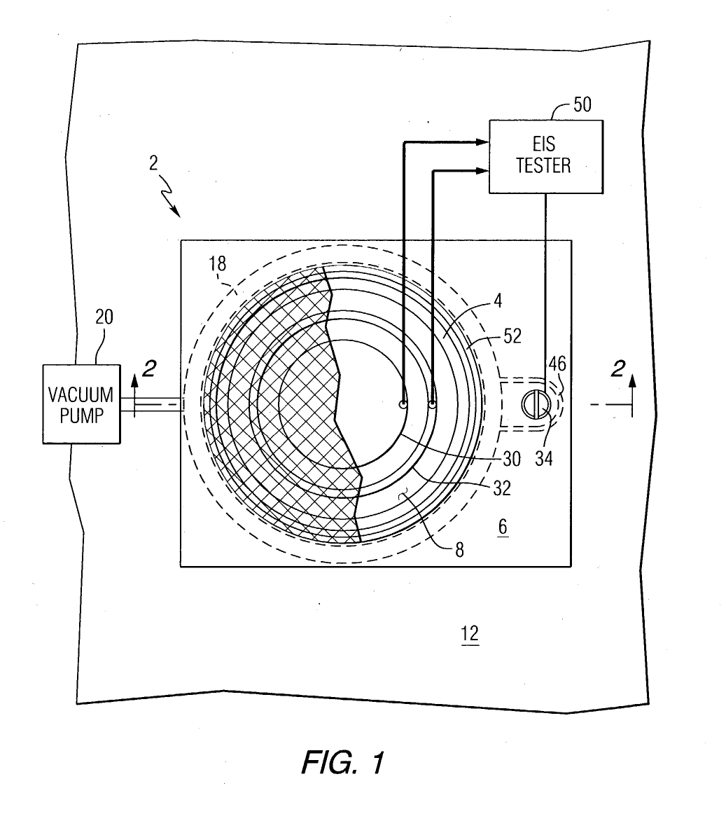

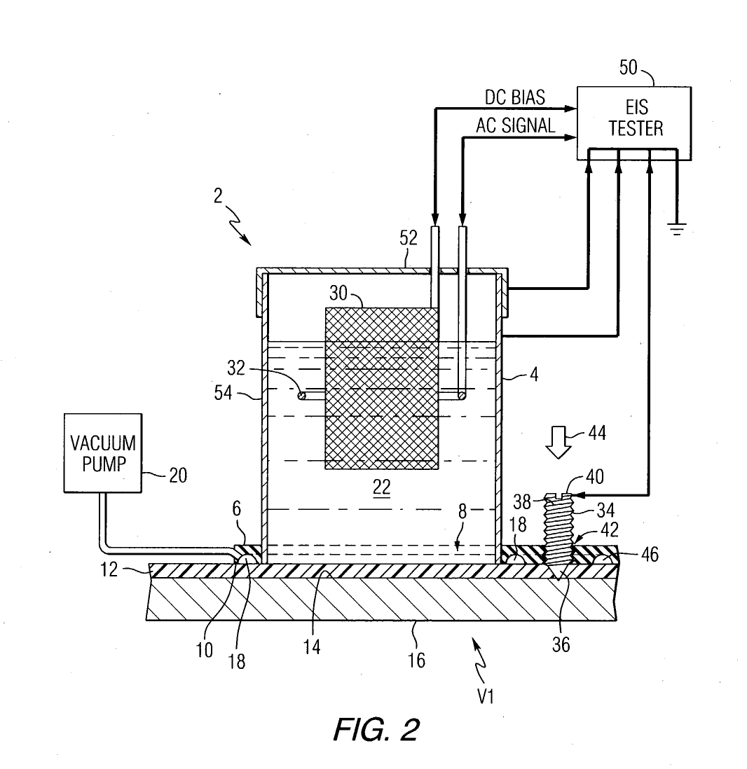

With reference to FIGS. 1 and 2, an electrochemical impedance spectroscopy (EIS) apparatus 2 includes an electrically insulative conduit 4, which is open at both ends thereof, and a gasket 6 coupled in a fluid tight manner with conduit 4 adjacent one end thereof. Gasket 6 has an opening 8 therethrough in fluid communication with an interior of conduit 4. A side 10 of gasket 6 opposite conduit 4 is coupleable in a fluid tight manner with an insulative coating 12 deposited on a surface 14 of an object 16, e.g., an electrically conductive object. In the absence of coating 12 on surface 14, side 10 of gasket 6 is coupleable in a fluid tight manner directly to surface 14.

Side 10 of gasket 6 can include a vacuum channel 18 that surrounds opening 8. Vacuum channel 18 can be coupled in fluid communication with a vacuum pump 20 that is operative for drawing a vacuum on vacuum channel 18 thereby creating a suction force between gasket 6 and coating 12 or surface 14.

Gasket 6 can be formed from a pliable material that is responsive to a vacuum delivered to vacuum channel 18 for deforming as necessary to form a fluid tight seal around opening 8 whereupon a fluid 22 received in conduit 4 does not escape therefrom via opening 8. The foregoing description of gasket 6 being formed of a pliable material, however, is not to be construed as limiting the invention since the use of any suitable material that forms a fluid tight seal around opening 8 is envisioned. Moreover, the description of vacuum channel 18 coupled in fluid communication with vacuum pump 20 is not to be construed as limiting the invention since vacuum channel 18 can be configured to form a vacuum therein in response to forcibly moving side 10 of gasket 6 into contact with coating 12 or surface 14. To this end, vacuum channel 18 can be configured to create a suction force between gasket 6 and coating 12 or surface 14 in a manner similar to a suction cup. The use of channel 18 and/or vacuum pump 20 to form a fluid tight seal between gasket 6 and coating 12 or surface 14 is not to be construed as limiting the invention since any other means for creating a fluid tight seal therebetween is envisioned. For example, conduit 4 and gasket 6 can be coupled in a fluid tight manner to coating 12 or surface 14 utilizing suitable external mechanical and/or vacuum fixturing (not shown) known in the art. Examples of such external fixturing include clamps, suction cups and the like. The coupling of gasket 6 in a fluid tight manner with conduit 4 and coating 12 or surface 14 forms a fluid tight vessel V1 for holding fluid 22.

EIS apparatus 2 includes an electrically conductive counter electrode 30, reference electrode 32 and working electrode 34. Counter electrode 30 can be cup-shaped and can be formed from a platinum on niobium expanded mesh. Reference electrode 32 can be formed from a silver wire that surrounds and is in spaced relation to counter electrode 30. As shown in FIG. 2, counter electrode 30 and reference electrode 32 are positioned inside vessel V1 whereupon fluid 22 received therein contacts counter electrode 30 and reference electrode 32.

For the purpose of EIS testing, fluid 22 is a suitable electrolyte solution, such as (i) 0.1M sodium chloride (NaCl), (ii) a solution formed from 50% methyl carbitol and 50% H₂O+0.05 mM Na₂SO₄ or (iii) a NaCl agar gel, which is capable of conducting electrical current. However, the use of any suitable electrolyte solution is envisioned.

Working electrode 34 is positioned outside vessel V1. When utilized for contacting surface 14 directly, working electrode 34 can have any suitable shape and can be held in contact with surface 14 utilizing any suitable fixturing. When utilized for contacting surface 14 via coating 12, one end of working electrode 34 can have a tip 36 or other suitable means for piercing coating 12 and contacting surface 14 and, hence, object 16 in response to the application of a suitable force to working electrode 34. Working electrode 34 can be separate from vessel V1 or can be coupled to vessel V1. Moreover, working electrode 34 can have various forms and/or shapes. In the illustrated embodiment, working electrode 34 has an externally threaded body 38 extending between tip 36 and an end 40 opposite tip 36. In the embodiment shown in FIG. 2, externally threaded body 38 is configured to threadedly mate with an internally threaded aperture 42 formed in gasket 6. In response to the application of a suitable force in the direction of arrow 44 while rotating working electrode 34 in a suitable clockwise or counterclockwise direction, tip 36 moves into contact with and penetrates or pierces coating 12 to make contact with object 16.

To enable a suitable force to be applied to working electrode 34 in the direction of arrow 44, gasket 6 is in contact with coating 12 desirably in the presence of a vacuum in vacuum channel 18. However, any other means for maintaining gasket 6 in contact with coating 12 during application of the suitable force to working electrode 34 is envisioned. To avoid gasket 6 from separating from coating 12 during application of the force on working electrode 34 in the direction of arrow 44, a vacuum channel 46 can be provided surrounding internally threaded aperture 42. Vacuum channel 46 can be coupled to vacuum channel 18 or can be separate, isolated from vacuum channel 18. In either event, vacuum channel 46 operates in the same manner as vacuum channel 18. Namely, in the presence of a suitable vacuum therein, vacuum channel 46 creates a suction force between gasket 6 and coating 12. This suction force helps maintain gasket 6 in fluid tight contact with coating 12 when tip 36 pierces coating 12 in response to rotating working electrode 34 in a suitable direction in the presence of a force directed in the direction of arrow 44.

Counter electrode 30, reference electrode 32 and working electrode 34 are connected to an EIS tester 50. In operation, EIS tester 50 applies a suitable amplitude AC signal between counter electrode 30 and working electrode 34 and applies a suitable electrical bias to reference electrode 32. EIS tester 50 sweeps the AC signal between a first frequency and a second frequency. During the sweep of the AC signal, EIS tester 50 determines a response of coating 12 and/or object 16 thereto. Based on this response, a characteristic or property of coating 12, surface 14 and/or object 16 can be determined. The use of EIS tester 50 to apply suitable signals to electrodes 30, 32 and 34, to sweep the AC signal between a first frequency and a second frequency, to determine a response of coating 12, surface 14 and/or object 16 to the sweep of the AC signal and to determine from this response a characteristic or property thereof is well known in the art and is included herein only for the purpose of illustration.

To avoid external electromagnetic interference from affecting counter electrode 30 and reference electrode 32 when EIS tester 50 is determining the response of coating 12, surface 14 and/or object 16 to the swept AC signal, EIS apparatus 2 can include an electrically conductive cover 52 positioned on the end of conduit 4 opposite opening 8. EIS apparatus 2 can also or alternatively include an electrically conductive coating or film 54 on the exterior surface of conduit 6. Cover 52 and/or coating or film 54 can be connected to a suitable reference potential, such as ground, either directly or via EIS tester 50. Cover 52 can be formed from a conductive mesh having a mesh size that blocks the entry of electromagnetic interference into conduit 4 while enabling the escape from conduit 4 of any gas generated by fluid 22 during EIS testing. However, cover 52 can be a solid cover having vent holes therein.

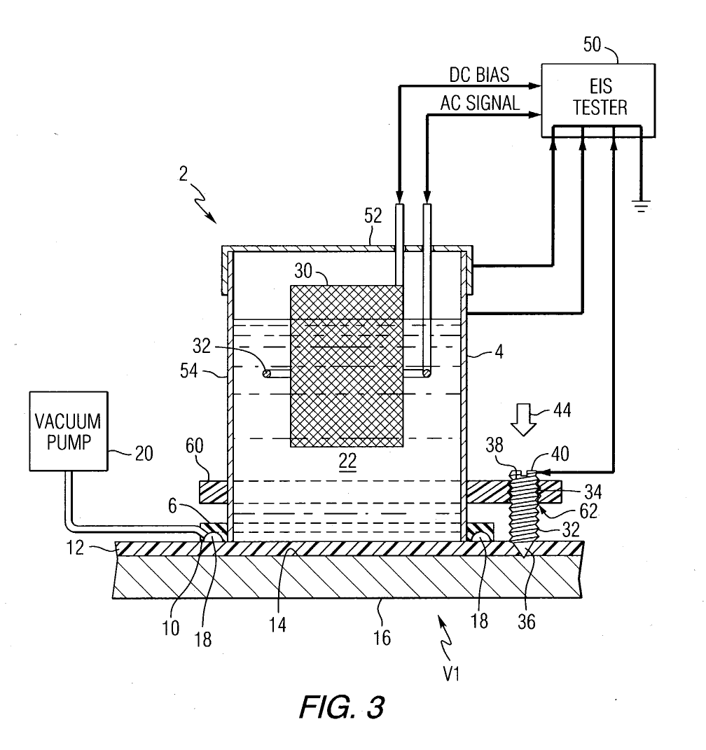

With reference to FIG. 3, and with continuing reference to FIGS. 1 and 2, in a variation of first embodiment EIS apparatus 2, internally threaded aperture 42 is omitted from gasket 6 and a bracket 60 having an internally threaded aperture 62 is substituted therefor. In use, bracket 60 is positioned on conduit 4 and externally threaded body 38 of working electrode 34 is threadedly mated with internally threaded aperture 62 of bracket 60. In response to a suitable clockwise or counterclockwise rotation in the presence of suitable force in the direction of arrow 44, tip 36 of working electrode 34 moves into contact with and pierces coating 12 thereby contacting object 16. To avoid movement of conduit 4 and gasket 6 relative to coating 12 when tip 36 is piercing coating 12, the rotation of working electrode 34 and the application force in the direction of arrow 44 occurs in the presence of a suitable vacuum in vacuum channel 18.

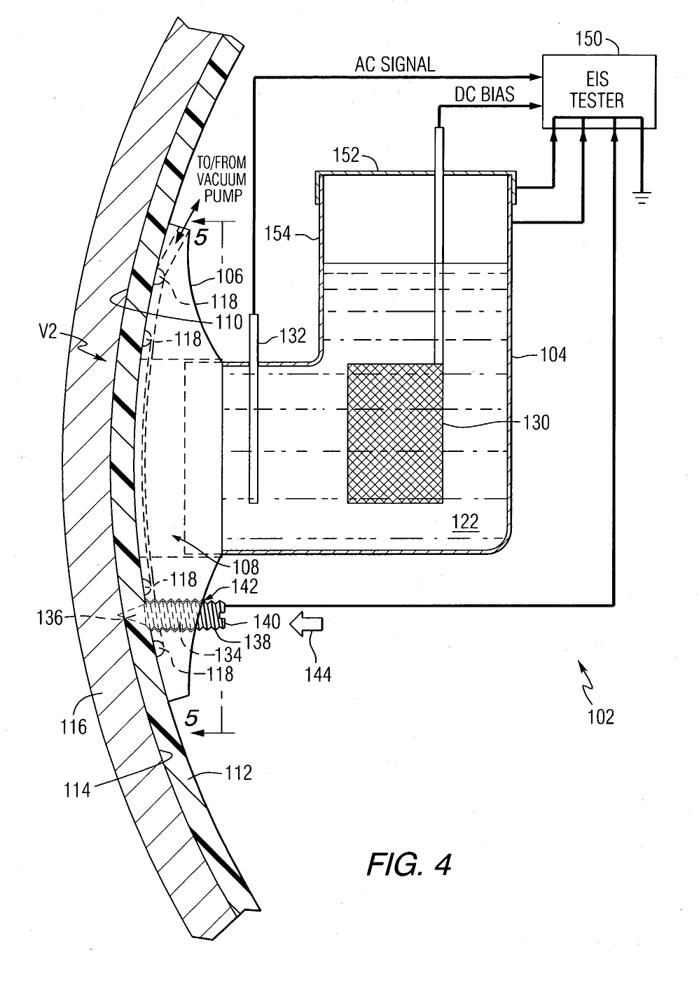

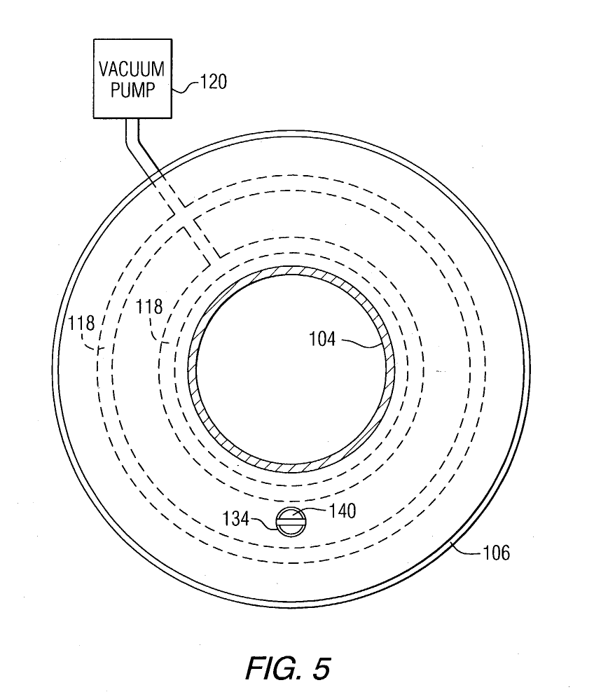

With reference to FIGS. 4 and 5, a second embodiment EIS apparatus 102 includes an electrically insulative conduit 104, which may be open at both ends thereof, having a gasket 106 coupled in a fluid tight manner to conduit 104 adjacent one end thereof. Gasket 106 has an opening 108 therethrough in fluid communication with an interior of conduit 104. A side 110 of gasket 106 opposite conduit 104 is coupleable in a fluid tight manner with an insulative coating 112 deposited on a surface 114 of an object 116, e.g., an electrically conductive object. In the absence of coating 112 on surface 1 14, side 110 of gasket 106 is coupleable in a fluid tight manner directly to surface 114.

Gasket 106 includes one or more vacuum channels 118 which can be coupled in fluid communication with a vacuum pump 120 which is operative for drawing a vacuum on each vacuum channel 118 thereby creating a suction force between gasket 116 and coating 112 or surface 114. Alternatively, each vacuum channel 118 can be configured to be operative in the manner of a suction cup for creating a suction force between gasket 106 and coating 112 or surface 114 when side 110 of gasket 106 is moved into contact therewith. However, this is not to be construed as limiting the invention since any other means for creating a fluid tight seal is envisioned. For example, conduit 104 and gasket 106 can be coupled in a fluid tight manner to coating 112 or surface 114 utilizing suitable external mechanical and/or vacuum fixturing (not shown) known in the art. Examples of such external fixturing include clamps, suction cups and the like. The coupling of gasket 106 in a fluid tight manner to conduit 104 and coating 112 or surface 114 forms a fluid tight vessel V2 for holding a fluid 122, like fluid 22 discussed above.

Gasket 106 can be formed from a material that is sufficiently pliable whereupon each vacuum channel 118 can generate a suction force between gasket 106 and an arcuate or curved surface of coating 112 or surface 114 while, at the same time, is sufficiently rigid to retain conduit 104 with the end thereof opposite opening 108 positioned transverse, e.g., perpendicular, to opening 108. The foregoing description of gasket 106 being formed of a pliable material, however, is not to be construed as limiting the invention since the use of any suitable material that enables a fluid tight seal to be formed between gasket 106 and a curved surface of coating 112 or surface 114 is envisioned.

In the second embodiment EIS apparatus 102 shown in FIG. 4, the ends of conduit 104 are positioned transverse to each other. More specifically, conduit 104 has an L-shape with the ends of conduit 104 positioned perpendicular to each other. The shape of conduit 104 enables second embodiment EIS apparatus 102 to be utilized for EIS testing of surfaces oriented other than horizontally, e.g., vertically or between horizontally and vertically. Moreover, the pliability of gasket 106 enables second embodiment EIS apparatus 102 to be used on arcuate or curved surfaces. The shape of conduit 104 shown in FIG. 4, however, is not to be construed as limiting the invention since conduit 104 can have any suitable shape that enables fluid 122 to be retained therein when one end of conduit 104 is coupled by gasket 106 in a fluid tight manner to a surface of coating 112 or surface 114 that is positioned at an angle other than horizontal.

Second embodiment EIS apparatus 102 includes counter electrode 130, an electrically conductive reference electrode 132 and an electrically conductive working electrode 134. Counter electrode 130 and reference electrode 132 are positioned inside vessel V2 whereupon fluid 122 received therein contacts counter electrode 130 and reference electrode 132. Counter electrode 130 is the same as counter electrode 30 discussed above in connection with the first embodiment EIS apparatus 2. In contrast to reference electrode 32, however, reference electrode 132 is spaced between counter electrode 130 and coating 112 or surface 114. In one exemplary embodiment, reference electrode 132 is spaced from counter electrode 130 and coating 112 or surface 114 by distances of approximately 2-6 centimeters and 1-3 centimeters, respectively.

Working electrode 134 is positioned outside vessel V2. When utilized for contacting surface 114 directly, working electrode 134 can have any suitable shape and can be held in contact with surface 114 utilizing any suitable fixturing. When utilized for contacting surface 114 via coating 112, one end of working electrode 134 can have a tip 136 and an externally threaded body 138 configured to threadedly mate with an internally threaded aperture 142 formed in gasket 106. In response to rotation of working electrode 134 in a suitable direction in the presence of a force in the direction of arrow 144, tip 136 moves into contact with and pierces coating 112 to make contact with surface 114 and, hence, object 116.

The presence of a suitable vacuum in each vacuum channel 118 helps maintain gasket 106 in a fluid tight contact with coating 112 when tip 136 pierces coating 112 in response to rotation of working electrode 134 in the presence of a force directed in the direction of arrow 144.

Electrodes 130, 132 and 134 are connected to an EIS tester 150. Like EIS tester 50, EIS tester 150 applies a suitable AC signal between counter electrode 130 and working electrode 134 and applies a suitable electrical bias to reference electrode 132. EIS tester 150 sweeps the AC signal between a first frequency and a second frequency, determines a response of coating 112, surface 114 and/or object 116 to the swept AC signal and determines from the response a characteristic or property thereof.

Second embodiment EIS apparatus 102 can also include an electrically conductive cover 152, like cover 52 in the first embodiment EIS apparatus 2. Second embodiment EIS apparatus 102 can also or alternatively include an electrically conductive coating or film 154 on the outside surface of conduit 104. Cover 152 and/or coating 154 can be connected to a suitable reference potential, such as ground, either directly or via EIS tester 150.

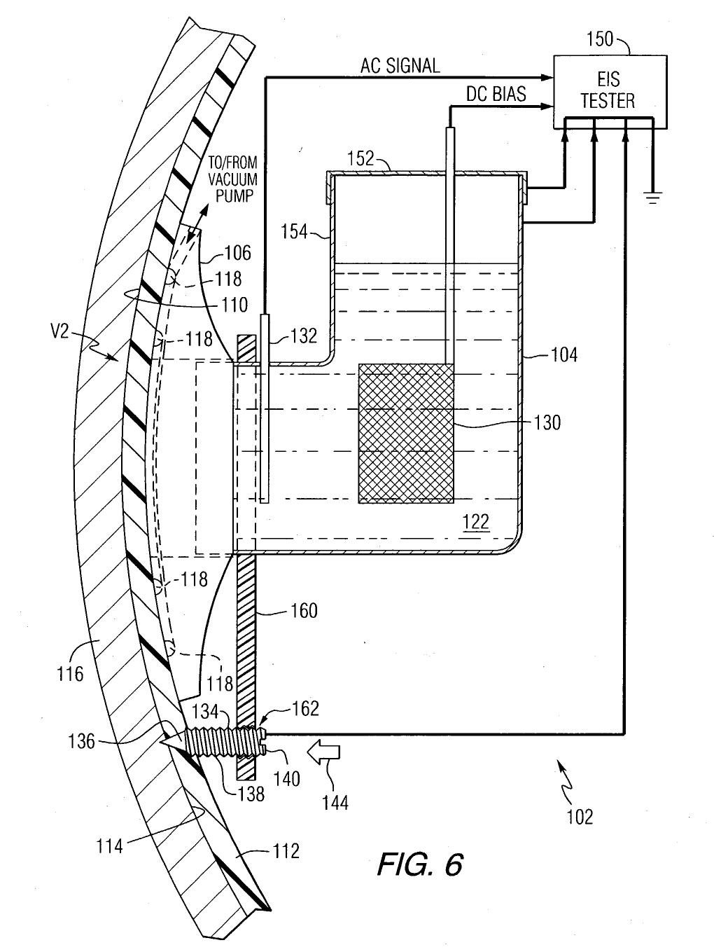

With reference to FIG. 6, and with continuing reference to FIGS. 4 and 5, in a variation of second embodiment EIS apparatus 102, internally threaded aperture 142 is omitted from gasket 106 and a bracket 160 having an internally threaded aperture 162 is substituted therefor. In use, bracket 160 is secured to conduit 104 and externally threaded body 138 of working electrode 134 is threadedly mated with internally threaded aperture 162 of bracket 160. In response to a suitable clockwise or counterclockwise rotation of working electrode 134 in the presence of a suitable force directed in the direction of arrow 144, tip 136 of working electrode 134 moves into contact with and pierces coating 112 to make contact with surface 114 and, hence, object 116.

When EIS testing is complete, EIS apparatus 2 or 102 is removed from the surface or from the coating deposited on the surface. Where the working electrode of EIS apparatus 2 or 102 pierced the coating to make contact with the object, each hole formed by the working electrode is sealed in any suitable manner.

As can be seen, the present invention provides an EIS apparatus and method of use thereof that can be used for testing a curved surface of an object or a surface of an object oriented other than horizontal. The present invention also enables direct EIS testing of the coating on an object while avoiding the need to remove a sample of the object including the coating thereon to perform EIS testing thereof.

The present invention has been described with reference to the preferred embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. An electrochemical impedance spectroscopy apparatus comprising:
a conduit;
a gasket coupled in a fluid tight manner to the conduit adjacent one end thereof, the gasket having an opening therethrough in fluid communication with an interior of the conduit, a side of the gasket opposite the conduit coupleable in a fluid tight manner with a coating applied over a surface of an object, wherein the conduit, the gasket and the coating define a fluid tight vessel when the gasket is coupled in a fluid tight manner to the coating;
a first electrode positioned inside the vessel; and
a second electrode positioned outside the vessel and responsive to the application of a suitable force thereto for piercing the coating to electrically contact the object.

2. The apparatus of claim 1, wherein the second electrode is operatively coupled to the conduit via one of a support bracket and the gasket.

3. The apparatus of claim 2, wherein the second electrode has an externally threaded body that is configured to threadedly mate with an internally threaded opening through the one of the support bracket and the gasket.

4. The apparatus of claim 1, wherein the gasket is configured to create with the coating a vacuum therebetween when the gasket is moved into contact with the coating, said vacuum coupling the gasket and the coating together in the fluid tight manner.

5. The apparatus of claim 4, wherein the gasket includes a vacuum channel operative in the manner of a suction cup for coupling the gasket and the coating together in the fluid tight manner.

6. The apparatus of claim 1, further including means for fluidly connecting a vacuum source in fluid communication between the gasket and the coating when the gasket is in contact with the coating, the vacuum source operative on the means for fluidly connecting for coupling the gasket and the coating together in the fluid tight manner.

7. The apparatus of claim 6, wherein the fluid connecting means includes a channel formed in the side of the gasket opposite the conduit.

8. The apparatus of claim 1, wherein opposite ends of the conduit are positioned transverse with respect to each other.

9. The apparatus of claim 8, wherein the conduit has an L-shape.

10. The apparatus of claim 1, further including an electrically conductive cover positionable over the end of the conduit opposite the gasket.

11. The apparatus of claim 1, wherein the conduit is formed from an electrically nonconductive material having a coating of electrically conductive material on an exterior surface thereof.

12. An electrochemical impedance spectroscopy method comprising:
(a) providing a conduit having a first conductive probe positioned therein;
(b) coupling one end of the conduit in a fluid tight manner to a coating on a surface of an electrically conductive object whereupon an electrolyte solution disposed in the conduit is in fluid communication with the coating and the first conductive probe;
(c) perforating the coating outside the conduit with a second conductive probe whereupon the second conductive probe is in electrical contact with the object;
(d) coupling an AC signal between the first and second conductive probes;
(e) sweeping the AC signal between a first frequency and a second frequency;
(f) determining a response of the coating and the object to the swept AC signal; and
(g) determining from the response a characteristic or property of the coating.

13. The method of claim 12, wherein the conduit is electrically nonconductive.

14. The method of claim 13, further including:
providing an electrically conductive film on the exterior surface of the conduit; and
connecting the electrically conductive film to a reference potential.

15. The method of claim 12, further including:
providing an electrically conductive cover over the other end of the conduit; and
connecting the electrically conductive cover to a reference potential.

16. The method of claim 12, wherein opposite ends of the conduit are positioned transverse with respect to each other.

17. An electrochemical impedance spectroscopy apparatus comprising:
a conduit having a first electrically conductive probe positioned therein;
a seal for coupling one end of the conduit in a fluid tight manner to a coating on a surface of an electrically conductive object whereupon an electrolyte solution disposed in the conduit is in fluid communication with the coating and the first conductive probe;
a second electrically conductive probe configured to penetrate the coating outside the conduit and electrically contact the object; and
means for applying a sweep frequency AC signal to the first and second conductive probes, for determining a response of the coating and the object to the sweep frequency AC signal and for determining from the response a characteristic or property of the coating.

18. The apparatus of claim 17, wherein the conduit is electrically nonconductive.

19. The apparatus of claim 18, further including at least one of:
an electrically conductive film on the exterior surface of the conduit; and
an electrically conductive cover over the other end of the conduit.

20. The apparatus of claim 17, wherein a body of the conduit is formed whereupon when the one end of the conduit is coupled to the coating when the surface is positioned at an angle relative to horizontal, the electrolyte solution does not exit the other end of the conduit.

21. An electrochemical impedance spectroscopy apparatus comprising:
a conduit having ends that are positioned transverse with respect to each other;
a gasket coupled in a fluid tight manner to the conduit adjacent one end thereof, the gasket having an opening therethrough in fluid communication with an interior of the conduit, a side of the gasket opposite the conduit coupleable in a fluid tight manner with one of a surface of an object and a coating applied over the surface of the object, wherein the conduit, the gasket and the one of the surface and the coating define a fluid tight vessel when the gasket is coupled in a fluid tight manner thereto;
a first electrode positioned inside the vessel; and
a second electrode positioned outside the vessel and moveable into electrical contact with the object.

22. The apparatus of claim 21, wherein the second electrode is responsive to the application of a suitable force thereto for piercing the coating to electrically contact the object.

23. The apparatus of claim 21, wherein the second electrode is operatively coupled to the conduit via one of a support bracket and the gasket.

24. The apparatus of claim 23, wherein the second electrode has an externally threaded body that is configured to threadedly mate with an internally threaded opening through the one of the support bracket and the gasket.

25. The apparatus of claim 21, wherein the gasket is configured to create with the one of the surface and the coating a vacuum therebetween when the gasket is moved into contact therewith, said vacuum coupling the gasket and the one of the surface and the coating together in the fluid tight manner.

26. The apparatus of claim 25, wherein the gasket includes a vacuum channel operative in the manner of a suction cup for coupling the gasket and the one of the surface and the coating together in the fluid tight manner.

27. The apparatus of claim 21, further including means for fluidly connecting a vacuum source in fluid communication between the gasket and the one of the surface and the coating when the gasket is in contact therewith, the vacuum source operative on the means for fluidly connecting for coupling the gasket and the one of the surface and the coating together in the fluid tight manner.

28. The apparatus of claim 27, wherein the fluid connecting means includes a channel formed in the side of the gasket opposite the conduit.

29. The apparatus of claim 21, wherein the conduit has an L-shape.

30. The apparatus of claim 21, further including an electrically conductive cover positionable over the end of the conduit opposite the gasket.

31. The apparatus of claim 21, wherein the conduit is formed from an electrically nonconductive material having a coating of electrically conductive material on an exterior surface thereof.

32. An electrochemical impedance spectroscopy method comprising:
(a) providing a first conductive probe positioned in a conduit having ends that are positioned transverse with respect to each other;
(b) coupling one end of the conduit in a fluid tight manner to one of a surface of an electrically conductive object and a coating deposited on the surface of the object whereupon an electrolyte solution disposed in the conduit is in fluid communication with the first conductive probe and the one of the surface and the coating;
(c) electrically contacting the surface of the object with a second conductive probe one of directly and via the coating;
(d) coupling an AC signal between the first and second conductive probes;
(e) sweeping the AC signal between a first frequency and a second frequency;
(f) determining a response of the coating and the object to the swept AC signal; and
(g) determining from the response a characteristic or property of the coating.

33. The method of claim 32, wherein step (c) includes perforating the coating outside the conduit with a second conductive probe.

34. The method of claim 32, wherein the conduit is electrically nonconductive.

35. The method of claim 34, further including:
providing an electrically conductive film on the exterior surface of the conduit; and
connecting the electrically conductive film to a reference potential.

36. The method of claim 32, further including:
providing an electrically conductive cover over the other end of the conduit; and
connecting the electrically conductive cover to a reference potential.

37. An electrochemical impedance spectroscopy apparatus comprising:
a conduit having a first electrically conductive probe positioned therein;
a seal for coupling one end of the conduit in a fluid tight manner to a surface of an electrically conductive object or a coating on the surface whereupon an electrolyte solution disposed in the conduit is in fluid communication with the surface or the coating and the first conductive probe;
a second electrically conductive probe configured to electrically contact the object one of directly or via the coating; and
means for applying a sweep frequency AC signal to the first and second conductive probes, for determining a response of the object and/or the coating to the sweep frequency AC signal and for determining from the response a characteristic or property thereof, wherein a body of the conduit is formed whereupon when the one end of the conduit is coupled to the coating when the surface is positioned at an angle relative to horizontal, the electrolyte solution does not exit the other end of the conduit.

38. The apparatus of claim 37, wherein the conduit is electrically nonconductive.

39. The apparatus of claim 38, further including at least one of:
an electrically conductive film on the exterior surface of the conduit; and
an electrically conductive cover over the other end of the conduit.

40. The apparatus of claim 37, wherein the second electrically conductive probe is configured to penetrate the coating outside the conduit whereupon the second electrically conductive probe contacts the object.
